(19) United States
(12) Patent Application Publication
(10) Pub. No.: US 2010/0156912 A1
(43) Pub. Date: Jun. 24, 2010

(54) MOTION SYNTHESIS METHOD

(75) Inventors: Man Kyu SUNG, Daejeon (KR); Il-Kwon Jeong, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/497,785

(22) Filed: Jul. 6, 2009

(30) Foreign Application Priority Data
Dec. 22, 2008 (KR) 10-2008-0131237

(51) Int. Cl. G06T 7/20; G06T 15/70

(52) U.S. Cl. 345/474; 382/107

(57) ABSTRACT

A motion synthesis method includes: analyzing a character's gait in motion capture data; creating motion capture data at different speeds having the analyzed gait; and storing the motion capture data at different speeds in a motion capture database. The method further includes: designating restrictions of a sketch including a trajectory and a speed tag of a desired motion; searching and extracting motion capture data corresponding to the speed tag from the motion capture database; and creating a motion satisfying the trajectory through synthesis by blending the motion capture data extracted from the motion capture database.

### CROSS-REFERENCE(S) TO RELATED APPLICATION

The present invention claims priority of Korean Patent Application No. 10-2008-0131237, filed on Dec. 22, 2008, which is incorporated herein by reference.

### FIELD OF THE INVENTION

The present invention relates to a motion synthesis method, and, more particularly, a motion synthesis method that enable animators to create desired long motions through the synthesis of motion capture data at fast speed in real time.

### BACKGROUND OF THE INVENTION

Animations using computer graphics are created mainly using a key-frame animation, a physics-based simulation or a motion capture.

The key-frame animation is one of the conventional methods. This is a method in which an animator designates main poses of an animation target object through manual work, and a computer automatically generates intermediate motions by using interpolation. Although this method enables animators to elaborately generate their desired animations, it has a disadvantage of requiring much trial and error and a long time.

The physics-based simulation is a method of creating animations of physical phenomena that are difficult for animators to manually create, e.g., water, fire and realistic cloth animations by using physical laws. The physics-based simulation is used for character animation. It is mainly used to manufacture a controller for controlling the motions of joints using a control algorithm that is used chiefly in robotics and to implement stable walking in various environments. In particular, the physics-based simulation has been widely used in the manufacture of ASIMO or Boston Dynamics' robots. Although this method has an advantage of enabling realistic animation, it has disadvantages in that it is difficult to model desired physical laws and simulation requires a considerably long time.

Further, in a case of human character animation which resembles human, since the motions of the character are very familiar with users, motions created by the physics-based method or the manual work-based key-frame animation method can be seen to be unrealistic. In order to solve this problem, there is proposed a motion capture method in which human's motions are directly recorded and used as data to create animation.

Although the motion capture method has the advantage of enabling hyper-realistic representation because human's motion is used as data without change, it has the disadvantage of using only captured motions.

In particular, in a case of capturing animal's motions of non-human characters, it is difficult to capture various motions because of hardness to control animals. Moreover, for a huge animal, it is difficult to perform long-time elaborate capture because it is difficult to acquire capture places and attach markers, and the cost thereof is very high.

Further, when the animal's motions are used in a movie or the like, animal motions of various steps and speeds are required. In this case, well trained animals and trainers capable of controlling the animals are required, so that the cost for the motion capture becomes much higher.

In order to overcome the disadvantages of such motion capture method, a method of creating new motions by converting a small amount of motion capture data was developed. A motion blending method, a motion graph method or a motion creation modeling method is used as the method.

The motion blending method is a technique for creating new motion data by interpolating between motion capture clips using a blending function. The motion graph method is a technique of analyzing original motion capture data and searching for frames having similar poses, to configure these frames into a graph, which is one of the data structures. That is, in the motion graph method, similar poses are represented using nodes of a graph, motion frames between two similar poses are represented into edges, and motions are created while traversing the graph. Further, the motion creation modeling method is a technique for forming a statistical or mathematical motion creation model, by learning capture motion data and then creating new motions using the model.

As described above, the method of creating animation using motion capture data by the conventional technologies has the advantage of representing hyper-realistic motions, but it has the disadvantage of using only captured motions. In order to overcome the disadvantage as described above, the method of creating new motions by converting a small amount of motion capture data was devised. However, it has a problem in that when animal's motions, e.g., quadruped animal's motions, are captured, it is difficult to create desired various motions at a fast speed.

### SUMMARY OF THE INVENTION

Therefore, the present invention provides a motion synthesis method enables animators to create desired long motions through the synthesis of motion capture data at fast speed in real time.

In accordance with an aspect of the present invention, there is provided a motion synthesis method, including: analyzing a character's gait in motion capture data; creating motion capture data at different speeds having the analyzed gait; storing the motion capture data at different speeds in a motion capture database; designating restrictions of a sketch including a trajectory and a speed tag of a desired motion; searching and extracting motion capture data corresponding to the speed tag from the motion capture database; and creating a motion satisfying the trajectory through synthesis by blending the motion capture data extracted from the motion capture database.

Said analyzing a character's gait in motion capture data may include: dividing the character's motion of the motion capture data into frames based on cycles; searching the frames for a frame corresponding to a restriction; and determining characteristics of the character's motion by analyzing a gait in the frame corresponding to the restriction.

Said searching for a frame corresponding to a restriction may include: searching the frames for a frame corresponding to local minima by using a speed threshold value and a height threshold value; and searching for the frame corresponding to the restriction around the frame corresponding to the local minima by using a distance threshold value.

Said determining characteristics of the motion is preferably performed by determining the characteristics of the motion based on a time when one or more feet among character's four feet come into contact with a ground and a number of feet making simultaneous ground contact at that time.

Said determining characteristics of the character's motion is preferably performed by determining the characteristics of the character's motion as one of a walk, a trot, a canter and a gallop.

Said creating motion capture data is preferably performed by adjusting speed of the motion in such a way as to change locations of steps of the motion.

Said changing of locations of steps is preferably performed by using a scalar value indicating magnitude of adjustment of the steps and a direction vector indicating a direction of the steps as variables.

In order to change the locations of the steps, a direction for the motion capture data is determined using a vector that connects a forefoot with a hind foot.

After changing the locations of the steps, angles between character's joints forming legs are preferably acquired using an Inverse Kinematics (IK) solver.

Said storing the motion capture data may be performed by storing the motion capture data in a table with speeds of the motion capture data being used as indices.

Said searching and extracting motion capture data is performed by, when a motion of a speed designated in the speed tag is not found, acquiring a motion of the designated speed in such a way as to extract two motion capture data of speeds closest to the speed designated in the speed tag and performing interpolation between the two motion capture data.

The interpolation may be spherical interpolation.

Said creating a motion satisfying the restriction of the trajectory through synthesis may include: locating a character at a start point of the trajectory included in the sketch; and creating the motion satisfying the restriction by changing a trajectory with respect to locations of root joints of the motion capture data extracted from the motion capture database and moving the character along the changed trajectory.

Said creating a motion is performed by acquiring a segment of a currently sketched trajectory by using a length of the trajectory of the motion capture data received from the motion capture database and changing root joints of the segment to be a same form of those in the motion capture data.

A foot skating phenomenon, which can appear after changing the root joints, may be removed by a cleanup process.

In said creating a motion, when the root joints are changed, trajectory of the segment may be fitted to a Bezier-spline curve and changed into a curve of a desired shape by adjusting a control point.

### BRIEF DESCRIPTION OF THE DRAWINGS

The above and other objects and features of the present invention will become apparent from the following description of preferred embodiments given in conjunction with the accompanying drawings, in which:

FIG. 1 illustrates a functional block diagram of a motion synthesis apparatus in accordance with an embodiment of the present invention;

FIG. 2 is a flow chart showing a motion synthesis method performed in the motion synthesis apparatus as shown in FIG. 1.

FIG. 3 is a flowchart illustrating a process of analyzing a gait of a motion in motion capture data in accordance with an embodiment of the present invention;

FIG. 4 is a flowchart illustrating a process of searching for a frame corresponding to a restriction in accordance with an embodiment of the present invention in greater detail;

FIG. 5 is a flowchart illustrating a process of creating a motion, satisfying the restriction of the trajectory, through synthesis in accordance with an embodiment of the present invention in greater detail;

FIGS. 6A to 6D are diagrams showing the characteristics of the gaits of a quadruped animal, wherein FIG. 6A shows the characteristics of a walk, FIG. 6B the characteristics of a trot, FIG. 6C the characteristics of a canter, and FIG. 6D shows the characteristics of a gallop;

FIGS. 7A to 7C are conceptual diagrams illustrating a process of adjusting location in accordance with an embodiment of the present invention; and

FIG. 8 is a diagram showing an example of a sketch of a motion drawn by a user in accordance with an embodiment of the present invention.

### DETAILED DESCRIPTION OF THE EMBODIMENTS

Hereinafter, embodiments of the present invention will be described in detail with reference to the accompanying drawings.

A motion synthesis in accordance with the present invention may be applied to both human character animation and animal motion animation of non-human characters. The following description will be given with reference to an example in which the present invention has been applied to animal motion animation that enables more efficient use.

In order to create a desired long motion through synthesis in real time by using animal motion capture data, the following technical requirements should be satisfied.

First, since animal motion capture data is difficult to capture, various motions requested by animators should be created by making the maximal use of a small amount of motion capture data.

Second, when an animator makes a schematic sketch of a desired motion, this sketch forms a restriction and the created motion should satisfy this restriction. In such a sketch, it is possible to set a speed, a location and a direction of a motion.

Third, a motion should maintain the characteristics of an animal motion, i.e., a walk-, trot-, canter- or gallop-type motion.

Fourth, a created motion should not exhibit any discontinuity.

Fifth, a motion should be created in real time.

A motion synthesis apparatus and method in accordance with the embodiment of the present invention which will now be described satisfies all of the above-described five technical requirements. Accordingly, it is possible to create desired long motions through the synthesis of animal motion capture data at fast speed in real time.

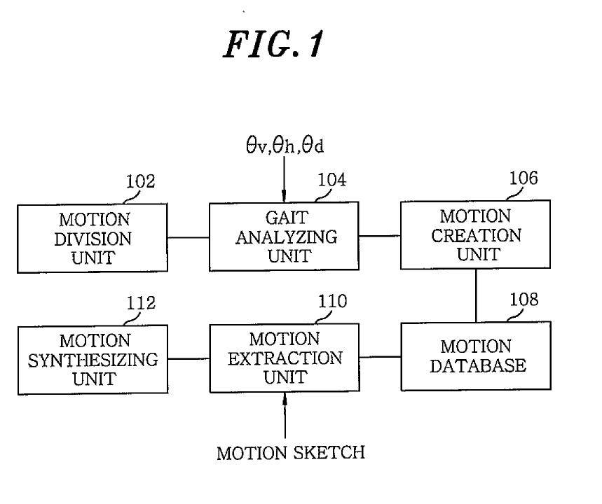

FIG. 1 is shows a functional diagram of a motion synthesis apparatus in accordance with the embodiment of the present invention. As shown in the drawing, the motion synthesis apparatus includes a motion division unit 102, a gait analyzing unit 104, motion creation unit 106, motion database 108, motion extraction unit 110 and motion synthesizing unit 112.

First, the motion division unit 102 analyzes a small amount of animal motion capture data divides the animal motion capture data into respective cycles. Since most motions are locomotive ones in which the motion of a character varies, every motion includes repeated motions. The cycles of the repeated motions may be detected through numerical calculation or manual work. In the case of manual work, cycles can be determined by comparing the poses of a character in specific frames. Since only one or two motions are input to the preprocessing module 10, the repeated motions can be detected at sufficiently fast speed even through manual work.

Furthermore, the gait analyzing unit 104 searches all cycle-based frames are automatically searched for a frame in which one or more feet among four feet come into contact with the ground. For this purpose, three threshold values, such as θᵥ indicative speed threshold value, θₕ indicative of height threshold value, and θ_{d} indicative of distance threshold value, are received from a user.

After a motion for each cycle has been received, the gait analyzing unit 104 searches a location p of a character end effect (i.e., foot), a distance h to the ground, and a speed v are calculated in each frame, and then a frame corresponding to the local minima. Herein, assuming that the location of the end effect is p(t) in frame t and mag(v) is a function for calculating the length of vector v, the following Equation 1 can be given:

h(t)=mag(p(t)−g(t)),

v(t)=mag(p(t−1)−p(t+1), (Eq. 1)

wherein g(t) is location of the ground.

The frame f corresponding to the local minima refers to a frame that satisfies the requirement of the following Equation 2.

f={t|h(t−1)>h(t)&h(t)<h(t+1),v(t)<θᵥ,h(t)<θₕ} (Eq. 2)

After the frame f corresponding to the local minima has been found, frames within a predetermined distance θ_{d} from the location of the frame fare searched. With this, frame f* corresponding to the restriction can be found, as shown in the following Equation 3:

f*={t|p(t)−p(f)<θ_{d}} (Eq. 3)

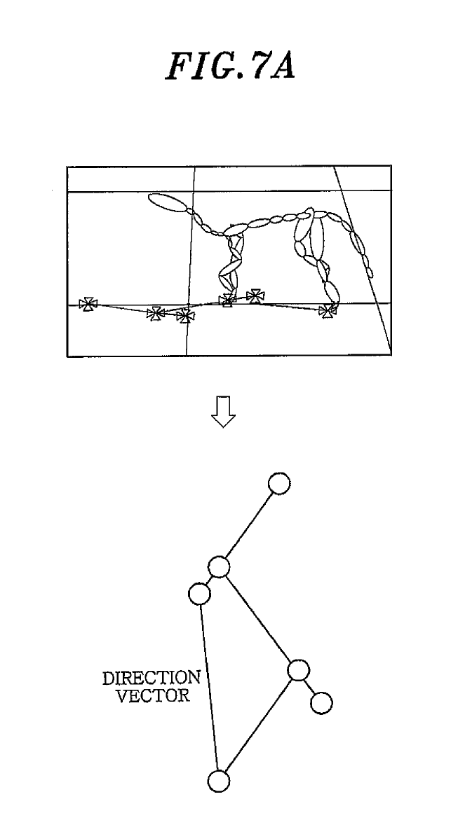

After the frame corresponding to the restriction of each motion has been found, the characteristics of the motion are determined through the analysis of the gait. The characteristics of the motion may be determined based on a time at which one or more feet among four feet come into contact with the ground and the number of feet (end effects) making simultaneous ground contact at that time. In the present invention, four types of motions such as a walk, a trot, a canter, and a gallop may be determined, as shown in FIGS. 6A to 6D.

FIGS. 6A to 6D are diagrams showing the characteristics of the gaits of a quadruped animal, wherein FIGS. 6A to 6D respectively show the characteristics of a walk, a trot, a canter, and a gallop, respectively.

Since the walk is composed of four beats, and four feet alternately come into contact with the ground in the sequence illustrated in FIG. 6A. The trot, which is faster than the walk, is composed of two beats, and it is performed in such a way that each of the two pairs of diagonal feet simultaneously comes into contact with the ground in the sequence illustrated in FIG. 6B. The canter is composed of three beats, and a pair formed with two diagonal feet and the other feet come into contact with the ground an alternate fashion illustrated in FIG. 6C. Further, the gallop is composed of four beats, and respective feet come into contact with the ground in the sequence illustrated in FIG. 6D. The canter and the gallop vary depending upon whether a leading foot is a left foot (left-lead) or a right foot (right-lead).

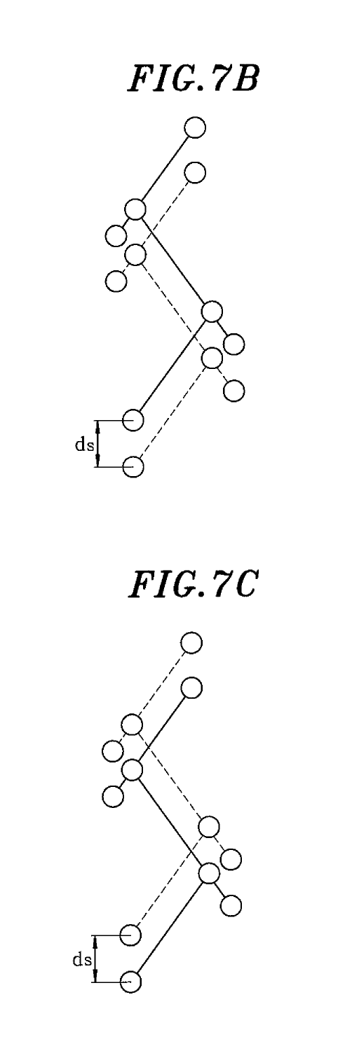

After the characteristics of the given motion have been determined through the analysis of the gait in the gait analyzing unit 104, the motion creation unit 106 creates a motion at a different speed by changing the locations of steps. That is, since the locations of steps affects the speed of the character, the speed of the motion can be adjusted by changing the locations of the steps forward or backward. The changes in the locations of steps are illustrated in FIGS. 7A to 7C. FIG. 7A shows original motion capture data, FIG. 7B shows motion capture data of which speed is adjusted to be faster than that in FIG. 7A, and FIG. 7C shows motion capture data of which speed is adjusted to be slower then that in FIG. 7A.

In the adjustment of steps, dₛ indicating the magnitude of adjustment and a direction vector indicating the direction of adjustment act as principal variables. dₛ is a scalar value. Herein, if dₛ has a value greater than 0, the speed of a motion is increased. In contrast, if dₛ has a value less than 0, the speed of a motion is decreased. The direction of adjustment determines the direction of a motion through a direction vector, which has a two-dimensional vector value. Since a changed motion needs to have a direction similar to that of an original motion, the direction of the character is determined by using a vector connecting a forefoot with a hind foot as the direction vector, as illustrated in FIG. 7A. Further, the speed of the changed motion is determined using the following Equation 4:

M(s)=(dₛ+d)|(t·f), (Eq. 4)

wherein M(s) is a speed of the changed motion, d is a sum of moving distances of the original motion's root joints, t is a time between frames and f is a total number of the frames.

After the locations of new steps have been determined, the configuration of new legs is determined using the Inverse Kinematics (IK) technique. The angles between joints forming legs needs to be changed because the locations of steps have been changed. Therefore, these angles can be obtained through an IK solver. After the angles have been obtained through the IK solver, it is determined whether the gait (i.e., feet contact sequence with the ground) obtained in the above-described gait analysis process is maintained. The reason for this is that an original gait should be maintained, even though speed has been changed.

The motions at different speeds are stored in a motion capture database in a form of a table, wherein the speeds of the motions are used as respective indices, as shown in Table 1.

TABLE 1

| speed | Motion (for example, file name) |
|---|---|
| 3.0 | C:\motions\walk3.0.bvh |
| 2.9 | C:\motions\walk2.9.bvh |
| 2.8 | C:\motions\walk2.8.bvh |
| . . . | . . . |
| 0 | C:\motions\walk0.bvh |
| −0.1 | C:\motions\walk-0.1.bvh |
| −0.2 | C:\motions\walk-0.2.bvh |
| . . . | . . . |
| −3.0 | C:\motions\walk-3.0.bvh |

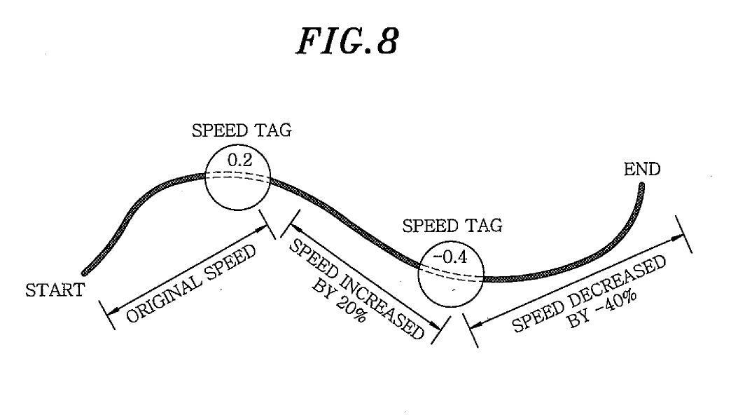

Meanwhile, the motion searching unit 110 receives a schematic sketch of a desired motion is received from an animator and extracts desired motion satisfying the sketch from the motion database 108. The sketch includes the trajectory and speed tags of the motion. FIG. 8 shows an example of such a sketch. The trajectory of a motion is a two-dimensional Bezier-spline curve that keeps track of the location of the root joint of a character, and speed tags are variables designating the speed of a motion.

As shown in FIG. 8, each speed tag is designated by clicking a specific location of a curve using a mouse and inputting a specific value. The speed tags indicate a speed of a motion. That is, a speed tag having a greater value than 0 indicates an increase in speed, and a speed tag having a smaller value than 0 indicates a decrease in speed. Further, it is assumed that the character moves at a constant speed in an interval between two speed tags. That is, in FIG. 8, a character moves at an original speed before a speed tag 0.2, moves at a speed of 0.2, i.e., the speed increased by 20%, in the interval between the speed tag 0.2 and speed tag −0.4, and moves at a speed decreased by 40% after the speed tag −0.4.

When a restriction is set, the motion extraction unit 110 searches the motion database 108 for the desired motions. However, since a motion of a set speed at a speed tag may not be found in the database, two motions of the most similar speeds are obtained from the database, and the motion of the desired speed is acquired by interpolation between the two motions.

Assuming that the speed of a desired motion is c′, two closest speeds are c1 and c2, a distance between the two closest speeds is d and the distance between c′ and c1 and the distance between c′ and c2 are dc1 and dc2, respectively, w (weight) used for acquiring the speed c′ of the desired motion is calculated by the following Equation 5:

dc1=abs(c−c1)

dc2=abs(c−c2)

d=abs(c1−c1)

w(c1)=(1−dc1/d)

w(c2)=(1−dc2/d) (Eq. 5)

The motion of the desired speed c′ is acquired in each frame through spherical interpolation between two motions by using the acquired w value.

After motions of speeds desired by the animator are acquired from the motion capture database, the motion synthesizing unit 112 creates a motion satisfying the trajectory restriction sketched by the animator by blending the acquired motions through synthesis. First, it is assumed that a character is located at the start point of a specific trajectory imparted as the restriction by an animator. In order to move the character along the trajectory, it is necessary to change a trajectory for the locations of the root joints of a motion acquired from the motion capture database. For this purpose, a segment of a currently sketched trajectory is acquired using a length of the trajectory of the motion data received from the motion capture database and root joints in the segment to be a same form of those in the motion capture data changed in the same form. Since the trajectory needs to be smooth when the root location is changed, the trajectory of the segment is fitted to a Bezier-spline curve and then changed into a curve of a desired shape by adjusting a control point.

Finally, when the location of the root joint is changed as described above, a foot skating which does not exist in an original motion occurs. The foot skating is removed through cleanup in the motion synthesizing unit 112.

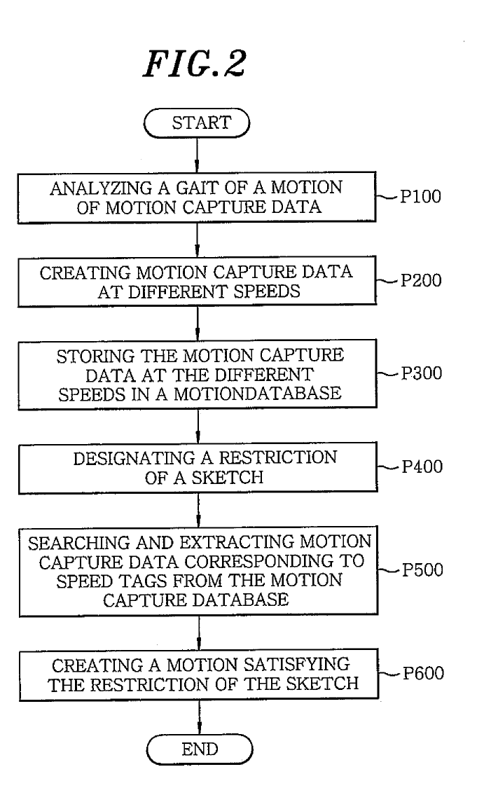

FIG. 2 shows processes P100 to P600 performed in the motion synthesis apparatus described above.

As illustrated in FIG. 2, a gait of a motion of motion capture data is analyzed as in process P100, motion capture data at different speeds having the analyzed gait is created as in process P200, and the motion capture data at the different speeds is stored in a motion capture database as in process P300. Further, restrictions of a sketch including a trajectory and speed tags of a desired motion is designated as in process P400, motion capture data corresponding to the speed tags is searched and extracted from the motion capture database as in process P500, and a motion satisfying the restrictions of the sketch is created through synthesis by blending the motion capture data extracted from the motion capture database as in process P600.

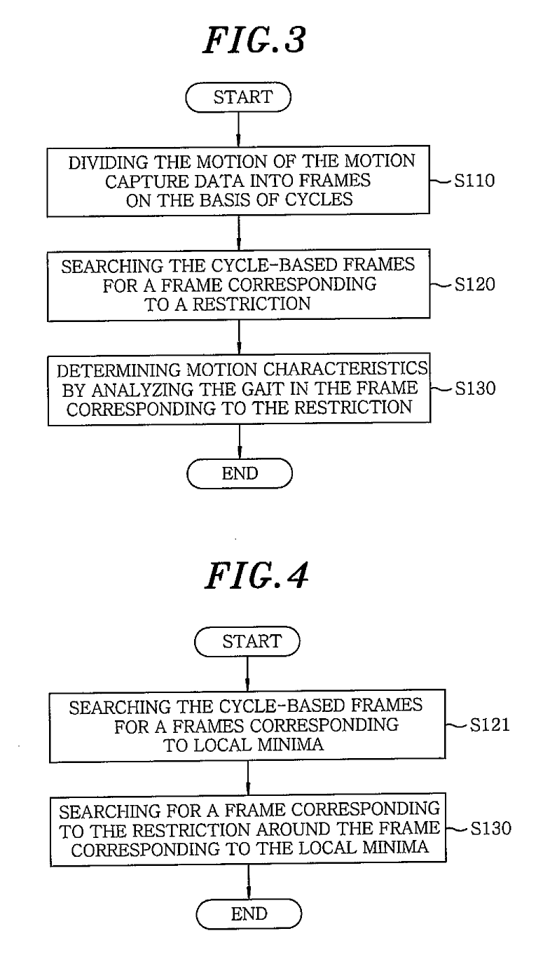

FIG. 3 is a flowchart illustrating the process P100 of analyzing the gait of a motion of motion capture data of FIG. 2 in accordance with the embodiment of the present invention in detail.

As illustrated in the drawing, the process P100 of analyzing the gait of motion capture data includes dividing the motion of the motion capture data into respective cycles in step S110, searching the cycle-based frames for a frame corresponding to a restriction in step S120, and determining motion characteristics by analyzing the gait in the frame corresponding to the restriction in step S130.

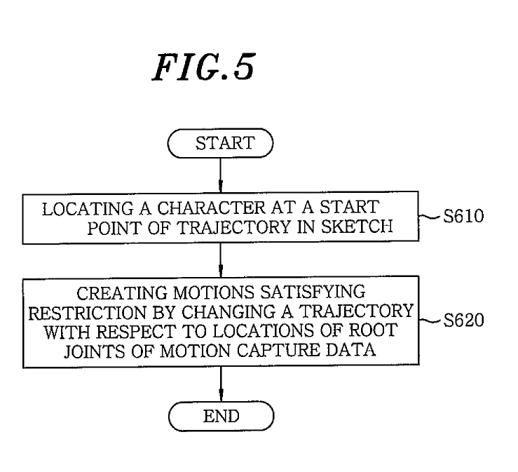

FIG. 4 is a flowchart illustrating the step S130 of searching for a frame corresponding to a restriction in accordance with the embodiment of the present invention in detail.

As illustrated in the drawing, the step S130 of searching for a frame corresponding to a restriction includes searching the cycle-based frames for a frame corresponding to local minima by using a speed threshold value and a height threshold value in step S123 and searching for a frame corresponding to the restriction around the frame corresponding to the local minima by using a distance threshold value in step S123.

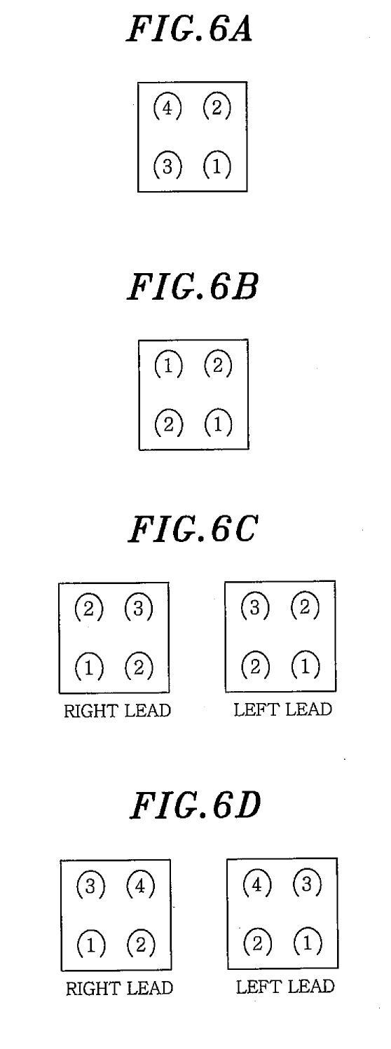

FIG. 5 is a flowchart illustrating creating a motion satisfying the restriction of the trajectory through synthesis in the process P600 in accordance with to the embodiment of the present invention in detail.

As illustrated in the drawing, the process P600 of creating a motion includes locating a character at the start point of the trajectory included in the sketch in step S610, and creating motions satisfying the restriction by changing a trajectory with respect to locations of root joints of the motion capture data extracted from the motion capture database and moving the character along the changed trajectory in step S620.

It is possible to construct the motion synthesis method in accordance with the present invention by using a computer program. The codes and code segments forming the computer program can be easily inferred by a computer programmer skilled in the art. Further, the corresponding computer program implements the motion synthesis method in such a way that it is stored in a computer-readable storage medium and is then read and executed by a computer. The storage medium includes a magnetic storage medium, an optical storage medium and a carrier wave medium.

While the invention has been shown and described with respect to the preferred embodiments, it will be understood by those skilled in the art that various changes and modifications may be made without departing from the scope of the invention as defined in the following claims.

What is claimed is:

1. A motion synthesis method, comprising:
analyzing a character's gait in motion capture data;
creating motion capture data at different speeds having the analyzed gait;
storing the motion capture data at different speeds in a motion capture database;
designating restrictions of a sketch including a trajectory and a speed tag of a desired motion;
searching and extracting motion capture data corresponding to the speed tag from the motion capture database; and
creating a motion satisfying the trajectory through synthesis by blending the motion capture data extracted from the motion capture database.

2. The motion synthesis method of claim 1, wherein said analyzing a character's gait in motion capture data includes:
dividing the character's motion of the motion capture data into frames based on cycles;
searching the frames for a frame corresponding to a restriction; and
determining characteristics of the character's motion by analyzing a gait in the frame corresponding to the restriction.

3. The motion synthesis method of claim 2, wherein said searching for a frame corresponding to a restriction includes:
searching the frames for a frame corresponding to local minima by using a speed threshold value and a height threshold value; and
searching for the frame corresponding to the restriction around the frame corresponding to the local minima by using a distance threshold value.

4. The motion synthesis method of claim 2, wherein said determining characteristics of the motion is performed by determining the characteristics of the motion based on a time when one or more feet among character's four feet come into contact with a ground and a number of feet making simultaneous ground contact at that time.

5. The motion synthesis method of claim 4, wherein said determining characteristics of the character's motion is performed by determining the characteristics of the character's motion as one of a walk, a trot, a canter and a gallop.

6. The motion synthesis method of claim 1, wherein said creating motion capture data is performed by adjusting speed of the motion in such a way as to change locations of steps of the motion.

7. The motion synthesis method of claim 6, wherein said changing of locations of steps is performed by using a scalar value indicating magnitude of adjustment of the steps and a direction vector indicating a direction of the steps as variables.

8. The motion synthesis method of claim 6, wherein in order to change the locations of the steps, a direction for the motion capture data is determined using a vector that connects a forefoot with a hind foot

9. The motion synthesis method of claim 6, wherein after changing the locations of the steps, angles between character's joints forming legs are acquired using an Inverse Kinematics (IK) solver.

10. The motion synthesis method of claim 1, wherein said storing the motion capture data is performed by storing the motion capture data in a table with speeds of the motion capture data being used as indices.

11. The motion synthesis method of claim 1, wherein said searching and extracting motion capture data is performed by, when a motion of a speed designated in the speed tag is not found, acquiring a motion of the designated speed in such a way as to extract two motion capture data of speeds closest to the speed designated in the speed tag and performing interpolation between the two motion capture data.

12. The motion synthesis method of claim 11, wherein the interpolation is spherical interpolation.

13. The motion synthesis method of claim 1, wherein said creating a motion satisfying the restriction of the trajectory through synthesis includes:
locating a character at a start point of the trajectory included in the sketch; and
creating the motion satisfying the restriction by changing a trajectory with respect to locations of root joints of the motion capture data extracted from the motion capture database and moving the character along the changed trajectory.

14. The motion synthesis method of claim 13, wherein said creating a motion is performed by acquiring a segment of a currently sketched trajectory by using a length of the trajectory of the motion capture data received from the motion capture database and changing root joints of the segment to be a same form of those in the motion capture data.

15. The motion synthesis method of claim 14, wherein a foot skating phenomenon, which can appear after changing the root joints, is removed by a cleanup process.

16. The motion synthesis method of claim 14, wherein in said creating a motion, when the root joints are changed, trajectory of the segment are fitted to a Bezier-spline curve and changed into a curve of a desired shape by adjusting a control point.
